(19) United States
(12) Patent Application Publication
(10) Pub. No.: US 2019/0113785 A1
(43) Pub. Date: Apr. 18, 2019

(54) LIQUID CRYSTAL DISPLAY DEVICE

(71) Applicant: SHARP KABUSHIKI KAISHA, Sakai City, Osaka (JP)

(72) Inventors: TAKUMA TOMOTOSHI, Sakai City (JP); MITSUHIRO MURATA, Sakai City (JP); YOSUKE IWATA, Sakai City (JP)

(21) Appl. No.: 16/090,238

(22) PCT Filed: Mar. 22, 2017
(86) PCT No.: PCT/JP2017/011310

§ 371 Date: Sep. 29, 2018

(30) Foreign Application Priority Data
Mar. 29, 2016 (JP) 2016-066396

(51) Int. Cl. G02F 1/1337; G02F 1/137; G02F 1/1343

(52) U.S. Cl. CPC G02F 1/1337; G02F 1/137; G02F 1/134309; G02F 2001/134372; G02F 2201/123; G02F 2201/121; G02F 2001/13712

(57) ABSTRACT

The present invention provides a horizontal alignment-mode liquid crystal display device enabling higher definition, more rapid response, and a higher transmission. The liquid crystal display device of the present invention includes, in the given order: a first substrate; a liquid crystal layer containing liquid crystal molecules; and a second substrate. The first substrate includes a first electrode, a second electrode closer to the liquid crystal layer than the first electrode is, and an insulating film between the first electrode and the second electrode. The second electrode is provided with an opening having a longitudinal shape with no protruding portion. The liquid crystal molecules are aligned parallel to the first substrate in a no-voltage-applied state where no voltage is applied between the first electrode and the second electrode. The liquid crystal molecules have negative anisotropy of dielectric constant. The opening provides four liquid crystal domains in a voltage-applied state where voltage is applied between the first electrode and the second electrode.

### TECHNICAL FIELD

The present invention relates to liquid crystal display devices. The present invention more specifically relates to a liquid crystal display device suitable as a horizontal alignment-mode liquid crystal display device provided with high-definition pixels.

### BACKGROUND ART

Liquid crystal display devices are display devices that utilize a liquid crystal composition for display. A typical display mode thereof is applying voltage to a liquid crystal composition sealed between paired substrates to change the alignment state of liquid crystal molecules in the liquid crystal composition according to the applied voltage, thereby controlling the amount of light transmitted. These liquid crystal display devices, having characteristics such as thin profile, light weight, and low power consumption, have been used in a broad range of fields.

The display modes of liquid crystal display devices include horizontal alignment modes, which control the alignment of liquid crystal molecules by mainly rotating them in a plane parallel to the substrate surfaces. The horizontal alignment modes have received attention because these modes make it easy to achieve wide viewing angle characteristics. For example, the in-plane switching (IPS) mode and the fringe field switching (FFS) mode, both a type of horizontal alignment mode, are widely used in recent liquid crystal display devices for smartphones or tablet PCs.

There is continuing research and development of the horizontal alignment modes to achieve higher definition pixels, an improved transmittance, and an improved response speed to improve the display quality. With respect to techniques for improving the response speed, for example, Patent Literature 1 discloses a technique of providing a comb-teeth portion of a specific shape for a first electrode of a liquid crystal display device utilizing a fringe electric field.

Patent Literature 2 discloses, for a FFS-mode liquid crystal display, an electrode structure with slits each including two linear portions and a V-shaped portion that connects the two linear portions in a V-shaped manner. This literature discloses that the technique can reduce defects due to process variation, improving the display quality.

### CITATION LIST

### Patent Literature

Patent Literature 1: JP 2015-114493 A
Patent Literature 2: WO 2013/021929

### SUMMARY OF INVENTION

### Technical Problem

The horizontal alignment modes offer the advantage of wide viewing angles, but have the problem of slow response as compared to vertical alignment modes such as the multi-domain vertical alignment (MVA) mode. Although the technique of Patent Literature 1 can improve the response speed even in the horizontal alignment modes, the shape of the electrode is greatly limited for ultra-high-definition pixels of 800 ppi or more, for example, and thus a complicated electrode shape as disclosed in Patent Literature 1 is difficult to form.

In Patent Literature 2, the V-shaped portion in an opening of the electrode divides the alignment of liquid crystal molecules into two, upper and lower regions when voltage is applied, improving the display quality such as transmittance. In contrast, this technique fails to greatly increase the response speed. In order to achieve higher definition and a higher transmittance, further improvement is required.

The present inventors have thus performed various studies on an FFS-mode liquid crystal display device and found that the response speed can be increased even in the horizontal alignment mode as follows. Specifically, when voltage is applied, liquid crystal molecules are smoothly rotated at a pitch smaller than a certain pitch and four liquid crystal domains are formed. Liquid crystal molecules in adjacent liquid crystal domains are rotated in the opposite azimuths, whereby the liquid crystal is aligned in a bend- and splay-shaped manner in a narrow region, and the distortion force generated by this alignment enables rapid response. In order to achieve such rapid response, dark lines generated at the central portion of the four liquid crystal domains need to be fixed so as not to cause alignment shift in each liquid crystal domain when a high voltage is applied.

FIG. 25 is a schematic plan view showing a counter electrode and a pixel electrode of a FFS-mode liquid crystal display device of Comparative Embodiment 1 the present inventors have examined. FIG. 26 is a plan view showing the result of simulating the alignment distribution of liquid crystal molecules in the on state in the liquid crystal display device of Comparative Embodiment 1.

As shown in FIG. 25, in a FFS-mode liquid crystal display device according to Comparative Embodiment 1, liquid crystal molecules 21 having positive anisotropy of dielectric constant were used, and a counter electrode 14 provided with an opening 15 was disposed in the upper layer while a pixel electrode 12 was disposed in a lower layer. The opening 15 had a racetrack shape and was symmetrical about the initial alignment azimuth 22 of the liquid crystal molecules 21. In the FFS-mode liquid crystal display device according to Comparative Embodiment 1, as shown in FIG. 26, the liquid crystal molecules 21 were rotated and four liquid crystal domains were formed by voltage application. However, as the applied voltage was increased, the symmetry of the cross-shaped boundary (dark lines) among the liquid crystal domains generated at the center of a display unit 50 was gradually broken, as indicated in a region surrounded by dotted lines in FIG. 26. In particular, the position of the dark line in the lateral direction of the opening 15 gradually shifted upward or downward from the center. Thus, the response performance was impaired in Comparative Embodiment 1. As described above, the alignments of the liquid crystal molecules 21 having positive anisotropy of dielectric constant were likely to be broken when voltage was applied, and the dark lines were not fixed when a high voltage was applied. This is presumably because, when voltage is applied, the liquid crystal molecules 21 having positive anisotropy of dielectric constant rotate parallel to (along) the lines of electric force, and thus many liquid crystal molecules 21 are aligned such that the major axes thereof rise on the substrate.

In order to stabilize the dark lines even when a high voltage is applied, the present inventors have performed further studies. FIG. 27 is a schematic plan view showing a counter electrode and a pixel electrode of a FFS-mode liquid crystal display device of Comparative Embodiment 2 the present inventors have examined. FIG. 28 is a plan view showing the result of simulating the alignment distribution of liquid crystal molecules in the on state in the liquid crystal display device of Comparative Embodiment 2.

As shown in FIG. 27, in a FFS-mode liquid crystal display device according to Comparative Embodiment 2, liquid crystal molecules 21 having positive anisotropy of dielectric constant were used, and a counter electrode 14 provided with an opening 15 was disposed in the upper layer and a pixel electrode 12 was disposed in a lower layer. The opening 15 had a shape including a longitudinal portion 16 and a paired protruding portions 17 extending in the opposite directions from the longitudinal portion 16. This shape was symmetrical about the initial alignment azimuth 22 of the liquid crystal molecules 21.

As shown in FIG. 28, in the FFS-mode liquid crystal display device according to Comparative Embodiment 2, the liquid crystal molecules 21 were rotated and four liquid crystal domains with the alignments of liquid crystal molecules 21 symmetrical with each other were formed by voltage application. Further, even when a higher voltage was applied, an electric field in an oblique direction in the paired protruding portions 17 was able to stabilize the presence of the four liquid crystal domains, improving the response performance. As described above, even with the liquid crystal molecules 21 having positive anisotropy of dielectric constant, the presence of the protruding portions 17 in the opening 15 was able to fix the cross-shaped dark lines and form the four liquid crystal domains even when a higher voltage was applied, improving the response speed, as indicated in a region surrounded by dotted lines in FIG. 28.

However, in the FFS-mode liquid crystal display device according to Comparative Embodiment 2 including the liquid crystal molecules 21 having positive anisotropy of dielectric constant, the paired protruding portions 17 need to be disposed in the opening 15 of the counter electrode 14. In order to achieve higher definition, further improvement is required.

The present invention has been made in view of the above current state of the art, and aims to provide a horizontal alignment-mode liquid crystal display device that achieves higher definition, more rapid response, and a higher transmittance.

### Solution to Problem

The present inventors performed various studies on horizontal alignment-mode liquid crystal display devices enabling higher definition, more rapid response, and a higher transmittance, and found that, even with an opening in an electrode that is an opening having a longitudinal shape with no protruding portion, the alignment of liquid crystal molecules can be appropriately controlled by the use of liquid crystal molecules having negative anisotropy of dielectric constant and the presence of four liquid crystal domains for one opening when voltage is applied. This configuration enables higher definition, an improved response speed, and a higher transmittance, and thus the present inventors have arrived at the solution of the above problems, completing the present invention.

Specifically, one aspect of the present invention may be a liquid crystal display device including, in the given order: a first substrate; a liquid crystal layer containing liquid crystal molecules; and a second substrate, the first substrate including a first electrode, a second electrode closer to the liquid crystal layer than the first electrode is, and an insulating film between the first electrode and the second electrode, the second electrode being provided with an opening having a longitudinal shape with no protruding portion, the liquid crystal molecules being aligned parallel to the first substrate in a no-voltage-applied state where no voltage is applied between the first electrode and the second electrode, the liquid crystal molecules having negative anisotropy of dielectric constant, the opening providing four liquid crystal domains in a voltage-applied state where voltage is applied between the first electrode and the second electrode.

The opening may satisfy 1.5≤A/B≤2.3, where A represents the length of the opening in the longitudinal direction; and B represents the length thereof in the lateral direction.

The longitudinal direction of the opening may be perpendicular to the initial alignment azimuth of the liquid crystal molecules.

At least one end of the opening in the longitudinal direction may be rounded.

The four liquid crystal domains may be present respectively in four regions which are symmetrical about the longitudinal and lateral directions of the opening.

Both ends of the opening in the longitudinal direction may be rounded.

### Advantageous Effects of Invention

The present invention can provide a horizontal alignment-mode liquid crystal display device enabling higher definition, more rapid response, and a higher transmittance.

### BRIEF DESCRIPTION OF THE DRAWINGS

FIG. 1 is a schematic cross-sectional view of a liquid crystal display device of Embodiment 1 in the off state.

FIG. 2 is a schematic plan view of the liquid crystal display device of Embodiment 1.

FIG. 3 is a schematic plan view of a counter electrode in the liquid crystal display device of Embodiment 1.

FIG. 4 is a schematic view illustrating alignment control of liquid crystal molecules in the on state in the liquid crystal display device of Embodiment 1.

FIG. 5 is a plan view showing the result of simulating the alignment distribution of liquid crystal molecules in the liquid crystal display device of Embodiment 1 at an applied voltage of 6 V.

FIG. 6 is a plan view of the central portion of FIG. 5.

FIG. 7 is a plan view of a counter electrode and a pixel electrode of a liquid crystal display device of Example 1.

FIG. 8 is a plan view showing the shape of an opening in the counter electrode of the liquid crystal display device of Example 1.

FIG. 9 is a plan view showing the result of simulating the alignment distribution of liquid crystal molecules in the liquid crystal display device of Example 1 at an applied voltage of 5 V.

FIG. 10 is a plan view showing the result of simulating the alignment distribution of liquid crystal molecules in the liquid crystal display device of Example 1 at an applied voltage of 6 V.

FIG. 11 is a plan view showing the result of simulating the alignment distribution of liquid crystal molecules in the liquid crystal display device of Example 1 at an applied voltage of 7 V.

FIG. 12 shows equipotential lines and action of liquid crystal molecules in the cross-section taken along the A-A′ line in FIG. 11.

FIG. 13 is a plan view showing the result of simulating the alignment distribution of liquid crystal molecules in a display unit of Comparative Example 1 at an applied voltage of 5 V.

FIG. 14 is a plan view showing the result of simulating the alignment distribution of liquid crystal molecules in a display unit of Comparative Example 1 at an applied voltage of 6 V.

FIG. 15 shows equipotential lines and action of liquid crystal molecules in the cross-section taken along the B-B′ line in FIG. 14.

FIG. 16 is a graph showing the relationship between the voltage and the transmittance in the liquid crystal display devices of Example 1 and Comparative Example 1.

FIG. 17 is a plan view showing the shape of an opening in a counter electrode of a liquid crystal display device of Example 2.

FIG. 18 is a plan view showing the shape of an opening in a counter electrode of a liquid crystal display device of Comparative Example 2.

FIG. 19 is a plan view showing the shape of an opening in a counter electrode of a liquid crystal display device of Comparative Example 3.

FIG. 20 is a plan view showing the result of simulating the alignment distribution of liquid crystal molecules in the liquid crystal display device of Example 2 at an applied voltage of 7 V.

FIG. 21 is a plan view showing the result of simulating the alignment distribution of liquid crystal molecules in the liquid crystal display device of Comparative Example 2 at an applied voltage of 6 V.

FIG. 22 is a plan view showing the result of simulating the alignment distribution of liquid crystal molecules in the liquid crystal display device of Comparative Example 3 at an applied voltage of 4 V.

FIG. 23 is a plan view showing the shape of an opening in a counter electrode of a liquid crystal display device of Example 3.

FIG. 24 is a schematic plan view for illustrating the length in the longitudinal direction and the length in the lateral direction of the opening in the counter electrode.

FIG. 25 is a schematic plan view showing a counter electrode and a pixel electrode of a FFS-mode liquid crystal display device of Comparative Embodiment 1 the present inventors have examined.

FIG. 26 is a plan view showing the result of simulating the alignment distribution of liquid crystal molecules in the on state in the liquid crystal display device of Comparative Embodiment 1.

FIG. 27 is a schematic plan view showing a counter electrode and a pixel electrode of a FFS-mode liquid crystal display device of Comparative Embodiment 2 the present inventors have examined.

FIG. 28 is a plan view showing the result of simulating the alignment distribution of liquid crystal molecules in the on state in the liquid crystal display device of Comparative Embodiment 2.

### DESCRIPTION OF EMBODIMENTS

Hereinafter, an embodiment of the present invention will be described. The following embodiment, however, is not intended to limit the scope of the present invention. The present invention may appropriately be modified within the scope of the configuration of the present invention.

The same components or components having the same or similar function are commonly provided with the same reference sign in the drawings, and description of such components is not repeated. The configurations described in the embodiment may appropriately be combined or modified within the spirit of the present invention.

### Embodiment 1

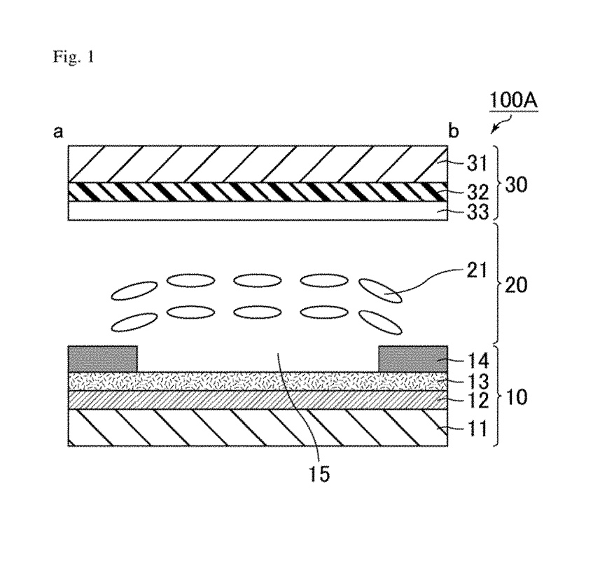

With reference to FIGS. 1 to 6, a liquid crystal display device of Embodiment 1 will be described below. FIG. 1 is a schematic cross-sectional view of a liquid crystal display device of Embodiment 1 in the off state.

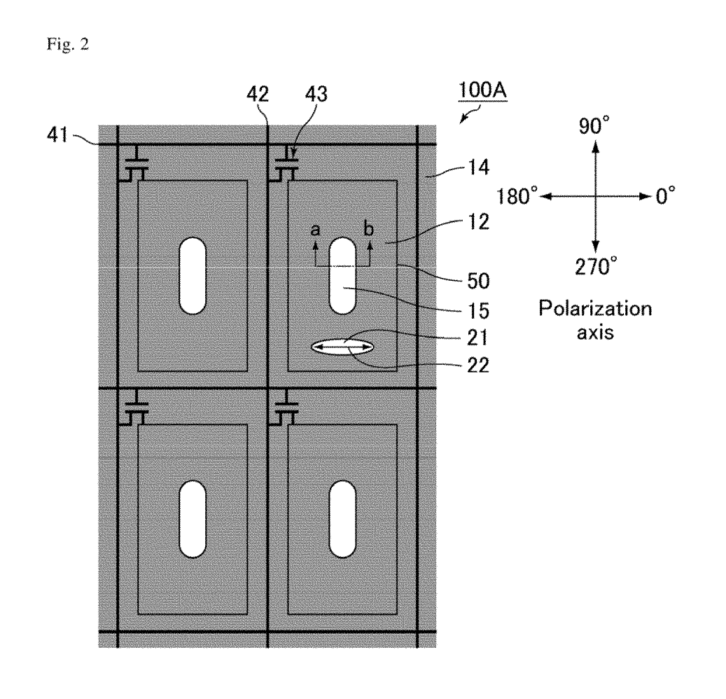

The cross-section shown in FIG. 1 is taken along the a-b line in FIG. 2.

As shown in FIG. 1, a liquid crystal display device 100A of Embodiment 1 includes, in the given order, a first substrate 10, a liquid crystal layer 20 containing liquid crystal molecules 21, and a second substrate 30. The first substrate 10 is a TFT array substrate and has a stacked structure including, in the order toward the liquid crystal layer 20, a first polarizer (not shown), an insulating substrate (e.g., glass substrate) 11, a pixel electrode (first electrode) 12, an insulating layer (insulating film) 13, and a counter electrode (second electrode) 14. The second substrate 30 is a color filter substrate and has a stacked structure including, in the order toward the liquid crystal layer 20, a second polarizer (not shown), an insulating substrate (e.g., glass substrate) 31, a color filter 32, and an overcoat layer 33. The first polarizer and the second polarizer are both absorptive polarizers and disposed in the crossed Nicols with their polarization axes perpendicular to each other.

The pixel electrode 12 is a planar electrode with no opening. The pixel electrode 12 and the counter electrode 14 are stacked together via the insulating layer 13. The pixel electrode 12 is positioned under the corresponding opening 15 disposed in the counter electrode 14. Thus, when a potential difference is generated between the pixel electrode 12 and the counter electrode 14, a fringe electric field is generated around the opening 15 in the counter electrode 14.

The pixel electrode 12 is an electrode provided for each display unit. The counter electrode 14 is an electrode common to multiple display units. The “display unit” means a region corresponding to one pixel electrode 12. The display unit may be one called “pixel” in the technical field of liquid crystal display devices, or may be one called “sub-pixel” or “dot” in cases where one pixel is divided for driving.

Since the counter electrode 14 provides a common potential to the respective display units, it may be formed on almost the entire surface (excluding the openings for producing a fringe electric field) of the first substrate 10. The counter electrode 14 may be electrically connected to an external connecting terminal at the periphery (frame region) of the first substrate 10.

The insulating layer 13 between the pixel electrode 12 and the counter electrode 14 may be, for example, an organic film (dielectric constant ε=3 to 4), an inorganic film (dielectric constant ε=5 to 7) such as a silicon nitride (SiNx) film or a silicon oxide (SiO₂) film, or a multilayer film containing any of these films.

The liquid crystal molecules 21 are those having a negative value for the anisotropy of dielectric constant (Δε) defined by the formula below. Liquid crystal molecules having positive anisotropy of dielectric constant are rotated parallel to (along) lines of electric force and are aligned such that the major axes of the liquid crystal molecules rise on the first substrate 10 when voltage is applied between the pixel electrode 12 and the counter electrode 14. Thus, such liquid crystal molecules are likely to cause break of the cross-shaped dark lines between the liquid crystal domains. The initial alignment azimuth 22 of the liquid crystal molecules 21 having positive anisotropy of dielectric constant is 90° rotated relative to the initial alignment azimuth 22 of the liquid crystal molecules 21 having negative anisotropy of dielectric constant.

Δε=(dielectric constant in the major axis direction)−(dielectric constant in the minor axis direction)

The liquid crystal molecules 21 having negative anisotropy of dielectric constant may have an anisotropy of dielectric constant of −6.0 to −2.0, preferably −4.0 to −3.0.

The liquid crystal molecules 21 having negative anisotropy of dielectric constant herein are also referred to as negative liquid crystal molecules. The liquid crystal molecules 21 having positive anisotropy of dielectric constant herein are also referred to as positive liquid crystal molecules.

In the no-voltage-applied state where no voltage is applied between the pixel electrode 12 and the counter electrode 14 (hereinafter, also referred to simply as the no-voltage-applied state or the off state), the alignment of the liquid crystal molecules 21 having negative anisotropy of dielectric constant is controlled to be parallel to the first substrate 10. The “parallel” includes not only being completely parallel, but also a range that can be equated with being parallel (substantially parallel) in the field of the art. The pre-tilt angle (inclination angle in the off state) of the liquid crystal molecules 21 having negative anisotropy of dielectric constant is preferably smaller than 3°, more preferably smaller than 1° relative to the surface of the first substrate 10.

In the voltage-applied state where voltage is applied between the pixel electrode 12 and the counter electrode 14 (hereinafter, also referred to simply as the voltage-applied state or the on state), voltage is applied to the liquid crystal layer 20 and the alignment of the liquid crystal molecules 21 having negative anisotropy of dielectric constant is controlled by the stacked structure of the pixel electrode 12, the insulating layer 13, and the counter electrode 14 in the first substrate 10.

The second substrate 30 may be any color filter substrate typically used in the field of liquid crystal display devices. The overcoat layer 33 flattens the liquid crystal layer 20 side surface of the second substrate 30, and may be an organic film (dielectric constant ε=3 to 4).

The first substrate 10 and the second substrate 30 are typically bonded to each other with a sealing material applied to surround the periphery of the liquid crystal layer 20. The first substrate 10, the second substrate 30, and the sealing material hold the liquid crystal layer 20 in a predetermined region. Examples of the sealing material include epoxy resins containing inorganic or organic filler and a curing agent.

The liquid crystal display device 100A may include components such as a backlight; optical films (e.g., a retardation film, a viewing angle-increasing film, and a luminance-increasing film); external circuits (e.g., a tape-carrier package (TCP) and a printed circuit board (PCB)); and a bezel (frame), in addition to the first substrate 10, liquid crystal layer 20, and second substrate 30. These components are not limited, and may be those usually used in the field of liquid crystal display devices. The description of these components is thus omitted.

The alignment mode of the liquid crystal display device 100A is the fringe field switching (FFS) mode.

Although not shown in FIG. 1, a horizontal alignment film is typically disposed on the surface closer to the liquid crystal layer 20 of the first substrate 10 and/or the second substrate 30. The horizontal alignment film acts to align liquid crystal molecules 21 near the film parallel to the film surface. In addition, the horizontal alignment film adjusts the orientations of the major axes of the liquid crystal molecules 21 aligned parallel to the first substrate 10 to a specific in-plane azimuth. The horizontal alignment film has preferably been subjected to alignment treatment such as photo-alignment treatment or rubbing treatment. The horizontal alignment film may be made of an inorganic material or an organic material.

The positions of the counter electrode 14 and the pixel electrode 12 may be switched. Specifically, although the counter electrode 14 is adjacent to the liquid crystal layer 20 via a horizontal alignment film (not shown) in the stacked structure shown in FIG. 1, the pixel electrode 12 may be adjacent to the liquid crystal layer 20 via the horizontal alignment film (not shown). In such a case, the opening 15 is formed not in the counter electrode 14 but in the pixel electrode 12. The counter electrode 14 corresponds to the first electrode, and the pixel electrode 12 corresponds to the second electrode.

FIG. 2 is a schematic plan view of the liquid crystal display device of Embodiment 1. As shown in FIG. 2, the display region of the liquid crystal display device 100A includes multiple display units 50 arranged in a matrix pattern. In a plan view, each opening 15 has a longitudinal shape with no protruding portion and is superimposed on the corresponding pixel electrode 12. These openings 15 are used for formation of a fringe electric field (oblique electric field). The openings 15 are preferably provided per display unit 50, and preferably provided for all the display units 50. One display unit 50 may include two or more openings 15.

In a plan view, the initial alignment azimuth 22 of the liquid crystal molecules 21 having negative anisotropy of dielectric constant is parallel to the polarization axis of one of the first polarizer and the second polarizer, and perpendicular to the polarization axis of the other. The control mode of the liquid crystal display device 100A is thus what is called a normally black mode, which provides black display when the liquid crystal layer 20 is in the no-voltage-applied state.

The initial alignment azimuth of liquid crystal molecules herein means the alignment azimuth of liquid crystal molecules in a no-voltage-applied state where no voltage is applied between the first electrode and the second electrode, i.e., between the pixel electrode and the counter electrode. The alignment azimuth of liquid crystal molecules means the orientation of the major axes of the liquid crystal molecules.

As shown in FIG. 2, the drain of a TFT 43 is electrically connected to the corresponding pixel electrode 12. To the gate of the TFT 43 is electrically connected a gate signal line (scanning conductive line) 41, and to the source of the TFT 43 is electrically connected a source signal line (signal conductive line) 42. Thus, the switching on/off of the TFT 43 is controlled by scanning signals input to the gate signal line 41. When the TFT 43 is on, data signals (source voltage) input to the source signal line 42 are provided to the pixel electrode 12 through the TFT 43. As described here, in the voltage-applied state, a source voltage is applied to the pixel electrode 12 that is a lower layer through the TFT 43, so that a fringe electric field is generated between the pixel electrode 12 and the counter electrode 14 that is disposed in an upper layer via the insulating film 13. The TFT 43 preferably has a channel formed from indium-gallium-zinc-oxygen (IGZO) which is an oxide semiconductor.

As shown in FIG. 2, the openings 15 in adjacent display units 50 in the counter electrode 14 are preferably arranged in line in the row direction and/or the column direction. This arrangement can stabilize the alignment of liquid crystal molecules 21 in the voltage-applied state. For example, arranging the openings 15 in adjacent display units 50 in a staggered manner in the row or column direction (e.g., arranging the opening 15 on one side of the longitudinal direction in a first display unit 50, while arranging the opening 15 on the other side of the longitudinal direction in a second display unit 50 adjacent to the first display unit 50) causes unstable alignment of the liquid crystal molecules 21, which may decrease the response speed.

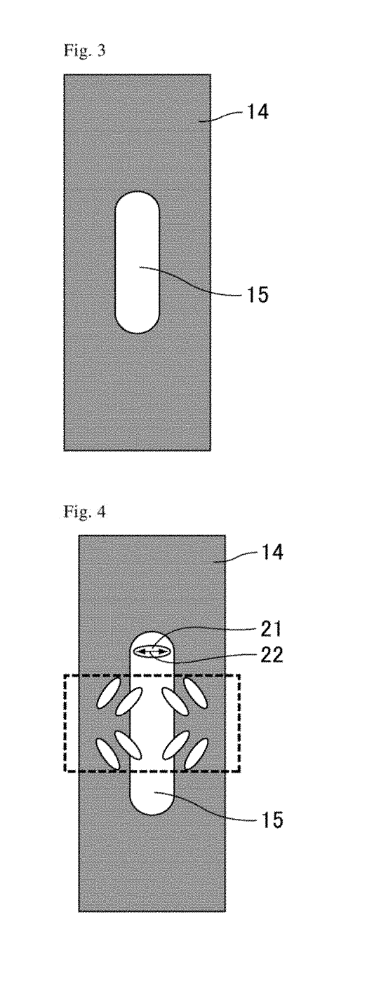

FIG. 3 is a schematic plan view of a counter electrode in the liquid crystal display device of Embodiment 1. The counter electrode 14 is provided with an opening 15 having a longitudinal shape with no protruding portion, as shown in FIG. 3. This opening 15 includes no complicated shape, and thus can be applied to ultra-high-definition pixels of 800 ppi or more without problems, for example.

The longitudinal shape with no protruding portion means the shape the length of which in the longitudinal direction is greater than the width in the lateral direction and which has substantially no protruding portion to the extent that enables the effects of the present invention. Thus, the longitudinal shape with no protruding portion may have irregularities that do not affect the alignment of the liquid crystal molecules 21 having negative anisotropy of dielectric constant. Still, the longitudinal shape with no protruding portion is preferably free from such irregularities. Specific examples of the longitudinal shape with no protruding portion include: ellipses; shapes similar to ellipses, such as egg-like shapes and racetrack shapes; longitudinal polygons such as rectangles; shapes similar to longitudinal polygons; longitudinal polygons with at least one corner rounded; and at least partially meandering shapes derived from these shapes. The racetrack shapes as used herein mean shapes each including two parallel lines of equal length and two semicircles.

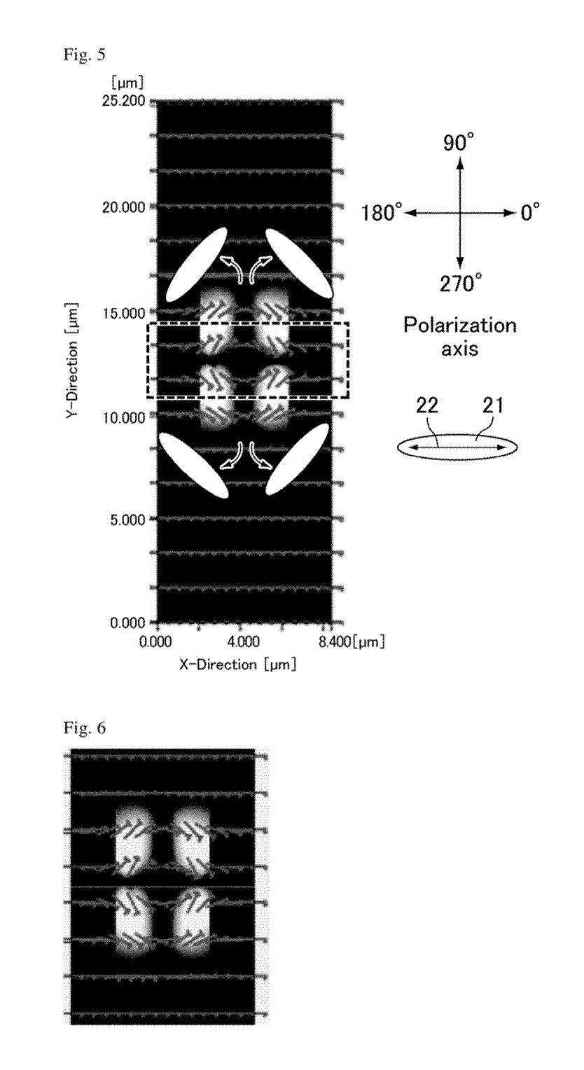

FIG. 4 is a schematic view illustrating alignment control of liquid crystal molecules in the on state in the liquid crystal display device of Embodiment 1. FIG. 5 is a plan view showing the result of simulating the alignment distribution of liquid crystal molecules in the liquid crystal display device of Embodiment 1 at an applied voltage of 6 V. FIG. 6 is a plan view of the central portion of FIG. 5.

As shown in FIG. 4 (especially, a region surrounded by broken lines), FIG. 5, and FIG. 6, as voltage is applied between the pixel electrode 12 and the counter electrode 14, the liquid crystal molecules 21 having negative anisotropy of dielectric constant are rotated and four liquid crystal domains are formed for one opening 15, providing symmetrical alignments of the liquid crystal molecules 21 on the opening 15. On the boundary of these four liquid crystal domains are present cross-shaped dark lines where the liquid crystal molecules 21 having negative anisotropy of dielectric constant do not move from the initial alignment azimuth 22. These moveless liquid crystal molecules 21 seem to serve as a wall that generates a force in the direction opposite to the rotational direction in each of the four liquid crystal domains, improving the response speed.

In the present embodiment, as shown in FIG. 5 and FIG. 6, the liquid crystal molecules 21 having negative anisotropy of dielectric constant can prevent break of the alignments of the liquid crystal molecules 21 having negative anisotropy of dielectric constant and maintain the symmetry of the four liquid crystal domains, fixing the cross-shaped dark lines and the bend- and spray-alignments even when the opening 15 is an opening having a longitudinal shape with no protruding portion and when a high voltage is applied. As described above, the alignments of the liquid crystal molecules 21 can be maintained even when a high voltage is applied, further improving the response speed, particularly the rise response speed.

Further, when voltage is applied, the liquid crystal molecules 21 having negative anisotropy of dielectric constant are rotated in a direction toward the direction vertical to lines of electric force, and are less likely to move in the cell-thickness direction than liquid crystal molecules having positive anisotropy of dielectric constant. In addition, as described above, a high voltage can be applied in the present embodiment. This enables improvement of the transmittance.

Each opening 15 has a longitudinal shape with no protruding portion, which allow the display unit 50 to have a narrow pitch in the lateral direction of the opening 15. In other words, such an opening enables higher definition than in the case where the opening 15 has a shape with a protruding portion.

The liquid crystal domain as used herein means a region defined by the boundary (dark lines) where the liquid crystal molecules 21 having negative anisotropy of dielectric constant in the liquid crystal layer 20 do not rotate from the initial alignment azimuth 22.

The opening 15 preferably satisfies 1.5≤A/B≤2.3, where A represents the length of the opening 15 in the longitudinal direction; and B represents the length thereof in the lateral direction. The opening 15 having the ratio A/B within the above range can more effectively fix the cross-shaped dark lines and more effectively stabilize the alignments of the liquid crystal molecules 21 even when a high voltage of 6 V or higher is applied. In contrast, if the ratio A/B is lower than 1.5 or higher than 2.3, the cross-shaped dark lines may be difficult to fix when a high voltage, e.g., 6 V or higher, is applied.

The ends of each opening 15 in the longitudinal direction may or may not be rounded. Preferably, at least one of the ends is rounded, and more preferably both of the ends are rounded. Each rounded end is preferably in the form of circle. This enables generation of an electric field in an oblique direction to the initial alignment azimuth 22 of the liquid crystal molecules 21 at a rounded end (preferably an end rounded in the form of circle), further fixing the alignments of the liquid crystal molecules 21 and further improving the response speed.

The longitudinal direction of the opening 15 is preferably perpendicular to the initial alignment azimuth 22 of the liquid crystal molecules 21 having negative anisotropy of dielectric constant. This enables easy formation of liquid crystal domains in the four regions symmetrical about the longitudinal and lateral directions of the opening 15 when voltage is applied. As a result, the four liquid crystal domains can exhibit better symmetry, further stabilizing the alignments of the liquid crystal molecules 21. The symmetry as used herein needs not to be complete symmetry, but may be substantial symmetry to the extent that can exert the effects of the present invention.

In order to allow the initial alignment azimuth 22 of the liquid crystal molecules 21 having negative anisotropy of dielectric constant to be perpendicular to the longitudinal direction of the opening 15, an alignment film has only to be subjected to photo-alignment treatment or rubbing treatment in the lateral direction of the opening 15 (the lateral direction of the display unit 50).

The operation of the liquid crystal display device 100A will be described hereinbelow.

In the liquid crystal layer 20 in the off state, no electric field is generated and the liquid crystal molecules 21 having negative anisotropy of dielectric constant are aligned parallel to the first substrate 10. Since the alignment azimuth of the liquid crystal molecules 21 having negative anisotropy of dielectric constant is parallel to the polarization axis of one of the first polarizer and the second polarizer, and since the first polarizer and the second polarizer are disposed in the crossed Nicols, the liquid crystal display device 100A in the off state does not transmit light and provides black display.

In the liquid crystal layer 20 in the on state, an electric field according to the level of the voltage between the pixel electrode 12 and the counter electrode 14 is generated. Specifically, since the opening 15 is formed in the counter electrode 14 arranged closer to the liquid crystal layer 20 than the pixel electrode 12 is, a fringe electric field is generated around the opening. The liquid crystal molecules 21 having negative anisotropy of dielectric constant rotate under the effect of the electric field to change their alignment azimuth from the alignment azimuth in the off state to the alignment azimuths in the on state The liquid crystal display device 100A in the on state thus transmits light to provide white display.

Each and every detail described for the above embodiment of the present invention shall be applied to all the aspects of the present invention.

The present invention is described below in more detail based on examples and comparative examples. The examples, however, are not intended to limit the scope of the present invention.

### Example 1

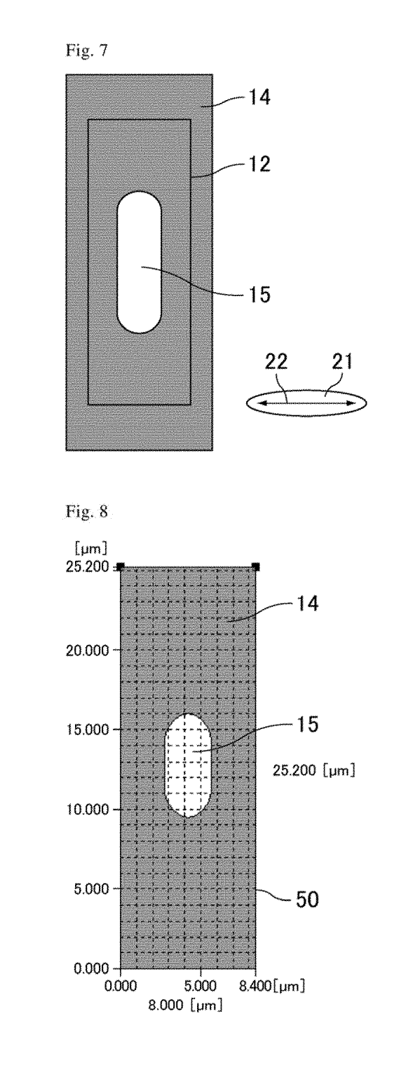

A liquid crystal display device of Example 1 is a specific example of the liquid crystal display device 100A of Embodiment 1 and has the following structure. FIG. 7 is a plan view of a counter electrode and a pixel electrode of a liquid crystal display device of Example 1. FIG. 8 is a plan view showing the shape of an opening in the counter electrode of the liquid crystal display device of Example 1.

For the counter electrode 14 of the liquid crystal display device 100A, the opening 15 was formed so as to have the shape as shown in FIGS. 7 and 8, i.e., a racetrack shape. For the liquid crystal layer 20, the refractive index anisotropy (Δn) was set to 0.11, the in-plane retardation (Re) was set to 330 nm, and the viscosity was set to 68 cps. The anisotropy of dielectric constant (Δε) of the liquid crystal molecules 21 having negative anisotropy of dielectric constant was set to −3.2 (negative), and the initial alignment azimuth 22 of the liquid crystal molecules 21 having negative anisotropy of dielectric constant was set to be perpendicular to the longitudinal direction of the display unit 50 and the opening 15. The polarizer was what is called a normally black mode polarizer that provides black display in a state (the off state) where no voltage is applied to the liquid crystal layer 20.

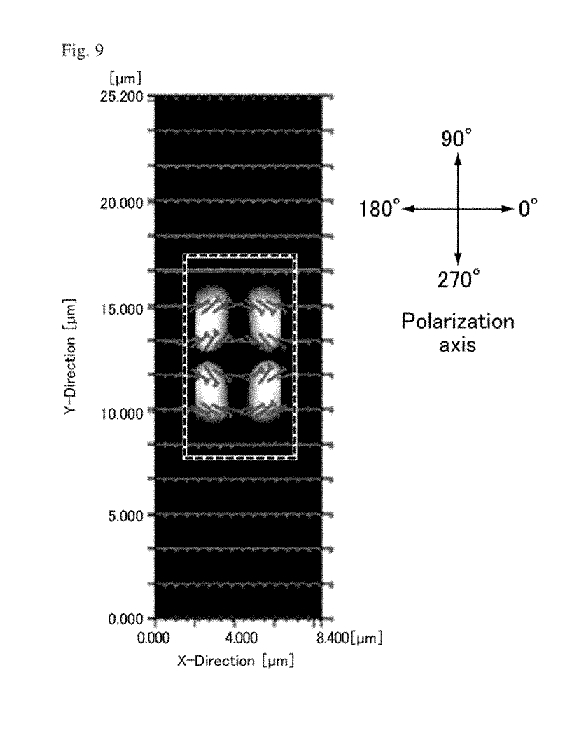

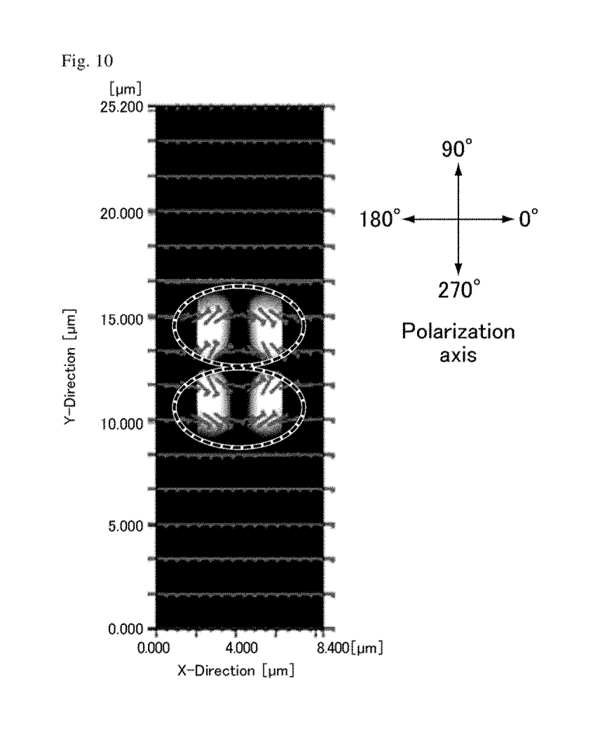

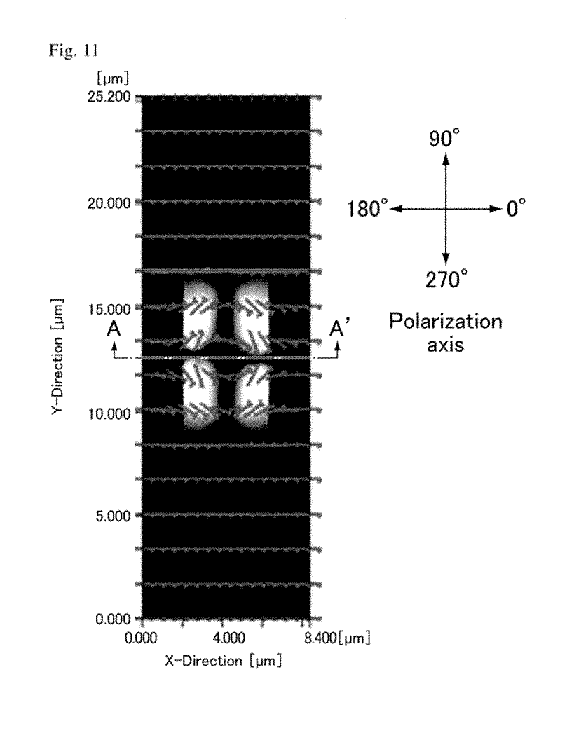

In accordance with FIG. 9 to FIG. 11, the following describes the alignment distribution of the liquid crystal molecules 21 in the on state (voltage-applied state) in the liquid crystal display device of Example 1. FIG. 9 to FIG. 11 are plan views showing the result of simulating the alignment distribution of liquid crystal molecules in the display unit of Example 1 at an applied voltage of 5 V, 6 V, and 7 V, respectively. The simulations of the examples and the comparative examples were performed using LCD-Master 3D (Shintech, Inc.).

As shown in FIG. 9 to FIG. 11, when voltage is applied between the pixel electrode 12 and the counter electrode 14, the liquid crystal molecules 21 having negative anisotropy of dielectric constant are rotated and the alignment state is changed. As indicated by a rectangular region surrounded by dotted lines in FIG. 9, even when a voltage of 5 to 7 V is applied, four liquid crystal domains are formed in the 45° direction from the center of the racetrack-shaped opening 15 relative to the longitudinal direction of the opening 15, and the liquid crystal molecules 21 in adjacent liquid crystal domains are aligned in the opposite azimuths. As described above, the liquid crystal molecules 21 having negative anisotropy of dielectric constant enables maintenance of the symmetry of the four liquid crystal domains even when a high voltage is applied. Further, the liquid crystal molecules 21 in the 45° direction from the center of the opening 15 relative to the longitudinal direction of the opening 15 can also be sufficiently rotated in an early stage of voltage application, leading to a higher transmittance.

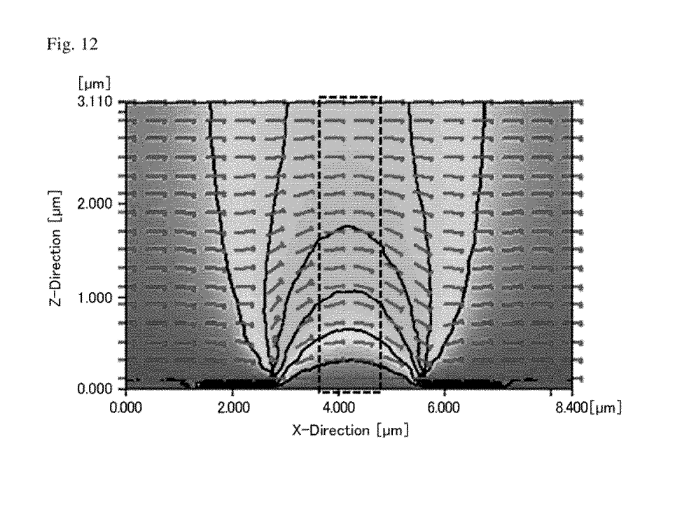

FIG. 12 shows equipotential lines and action of liquid crystal molecules in the cross-section taken along the A-A′ line in FIG. 11. The portion surrounded by dotted lines in FIG. 12 indicates the central portion of the cross-shaped dark lines and the vicinity thereof when voltage is applied. The liquid crystal molecules 21 having negative anisotropy of dielectric constant align perpendicularly to the lines of electric force, and thus the liquid crystal molecules 21 having negative anisotropy of dielectric constant align substantially parallel to the surface of the array substrate, as shown in FIG. 12. As a result, the alignments of the liquid crystal molecules 21 having negative anisotropy of dielectric constant seem to be less likely to break and seem to be stabilized even when a high voltage is applied.

### Comparative Example 1

A liquid crystal display device of Comparative Example 1 has a structure similar to that of the liquid crystal display device of Example 1, except that positive liquid crystal molecules 21 having an anisotropy of dielectric constant (Δε) of 3.2 were used instead of the negative liquid crystal molecules 21 and the initial alignment azimuth of the positive liquid crystal molecules 21 was adjusted to be parallel to the longitudinal direction of the opening.

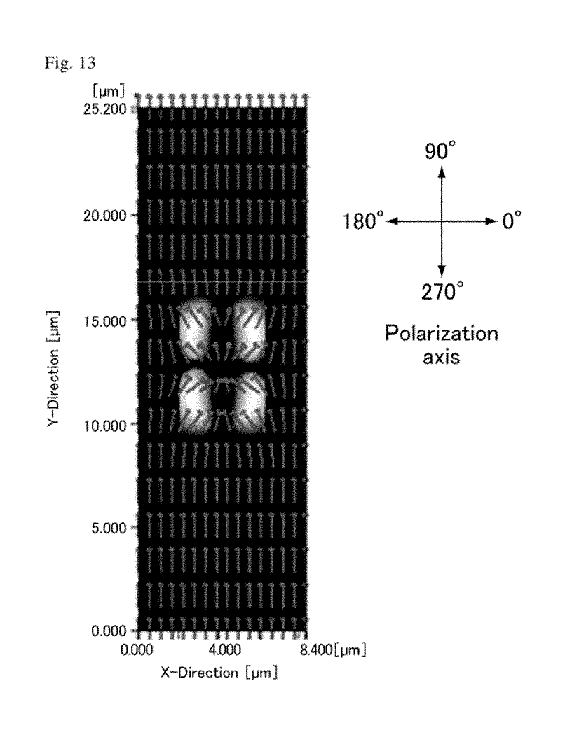

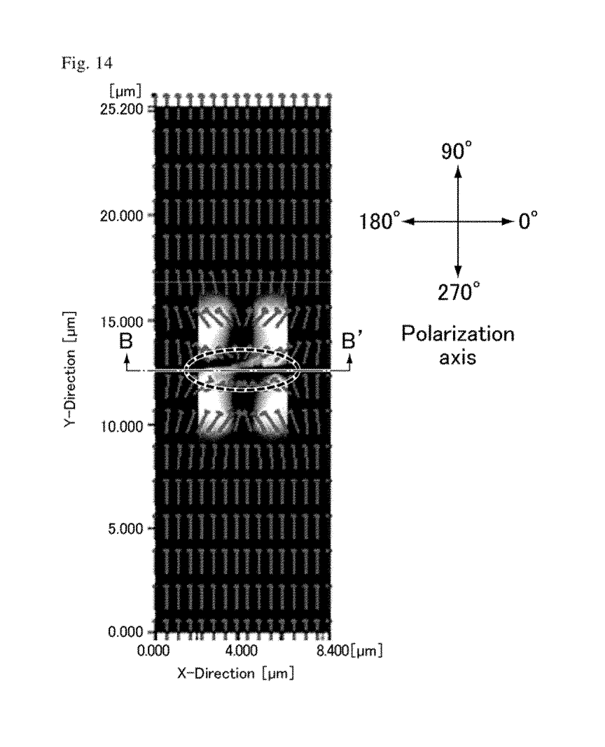

FIG. 13 and FIG. 14 are plan views showing the result of simulating the alignment distribution of liquid crystal molecules in a display unit of Comparative Example 1 at an applied voltage of 5 V and 6 V, respectively. As shown in FIG. 13, four liquid crystal domains are formed when a voltage of 5 V is applied, while the cross-shaped dark lines are not fixed but broken when a voltage of 6 V is applied, as indicated in the region surrounded by an ellipse in FIG. 14.

In comparison with the liquid crystal display device of Comparative Example 1 including the positive liquid crystal molecules 21, the liquid crystal display device of Example 1 including the negative liquid crystal molecules 21 can more stabilize the alignments of the liquid crystal molecules 21 even when a high voltage is applied. This is presumably because as follows.

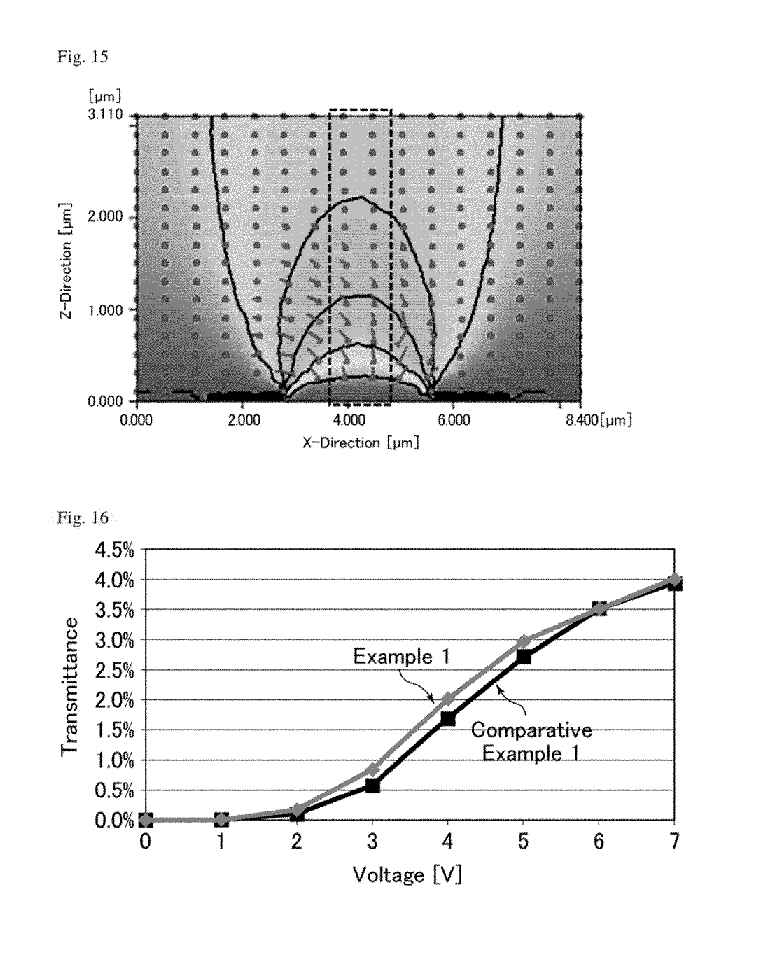

FIG. 15 shows equipotential lines and action of liquid crystal molecules in the cross-section taken along the B-B′ line in FIG. 14. The portion surrounded by dotted lines in FIG. 15 indicates the central portion of the cross-shaped dark lines and the vicinity thereof when voltage is applied. As described above, the negative liquid crystal molecules 21 are aligned substantially parallel to the surface of the array substrate, while the positive liquid crystal molecules 21 are aligned parallel to (along) the lines of electric force. Thus, as shown in FIG. 15, many positive liquid crystal molecules 21 are aligned so as to rise on the surface of the array substrate when voltage is applied. As a result, the alignments of the positive liquid crystal molecules 21 seem to be easily broken.

### Comparison of Example 1 and Comparative Example 1

The results of simulating the transmittance in Example 1 and Comparative Example 1 are described below.

When an applied voltage is 5 V or lower, as shown in FIG. 9 and FIG. 13, in the liquid crystal display devices of Example 1 and Comparative Example 1, the alignment of the liquid crystal molecules 21 is divided into four domains and the cross-shaped dark lines are fixed. FIG. 16 is a graph showing the relationship between the voltage and the transmittance in the liquid crystal display devices of Example 1 and Comparative Example 1. As shown in FIG. 16, when an applied voltage is 5 V or lower, the transmittance of the liquid crystal display device of Example 1 is equal to or higher than the transmittance in Comparative Example 1.

When an applied voltage is 6 V and 7 V, as shown in FIG. 16, the liquid crystal display devices of Example 1 and Comparative Example 1 have substantially the same transmittances. However, as shown in FIG. 14, the liquid crystal display device of Comparative Example 1 exhibits broken cross-shaped dark lines when a high voltage is applied, so that a voltage of 6 V or higher cannot be applied. Thus, the maximum voltage to be applied to the liquid crystal display device of Comparative Example 1 is 5 V and the transmittance is limited to 2.7%. In contrast, even a voltage of 7 V can be applied to the liquid crystal display device of Example 1 and the transmittance achieved was as high as 4.0%.

Next, the results of simulating the rise and decay responses in Example 1 and Comparative Example 1 are described below in accordance with the following evaluation standards.

### (Evaluation Standards)

The maximum transmittance obtained by optic modulation is defined as a transmittance percentage of 100%, and the rise response time is defined as the time required for a change in the transmittance percentage from 10% to 90%. The rise response performance corresponds to switching from black display to white display.

The liquid crystal display device of Comparative Example 1 exhibited a rise response time of 7.9 ms when a voltage of 5 V was applied, while the liquid crystal display device of Example 1 exhibited a rise response time of 7.3 ms when a voltage of 7 V was applied. The liquid crystal display device of Example 1 thus exhibited an improved response speed.

Consequently, Example 1 with the liquid crystal molecules 21 having negative anisotropy of dielectric constant better stabilized the alignment state of the liquid crystal molecules 21, provided a higher transmittance, and provided a higher response speed even when a high voltage was applied than Comparative Example 1 with the liquid crystal molecules 21 having positive anisotropy of dielectric constant. This is because Example 1 allows the cross-shaped dark lines to be fixed even when a high voltage is applied.

### Example 2 and Comparative Examples 2 and 3

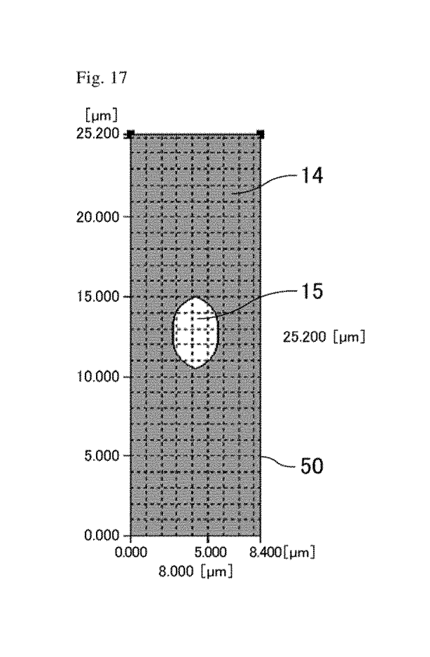

FIG. 17 to FIG. 19 are plan views showing the shape of an opening in a counter electrode of liquid crystal display devices of Example 2 and Comparative Examples 2 and 3, respectively. The liquid crystal display device 100A of Example 2 has a structure similar to that of the liquid crystal display device 100A of Example 1, except that the shape of the opening 15 in the counter electrode 14 was changed as shown in FIG. 17. The opening 15 in Example 2 has a shape obtained by contracting the opening 15 used in Example 1 in the longitudinal direction.

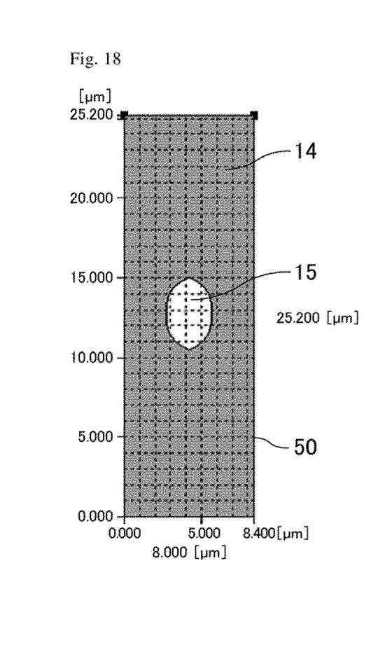

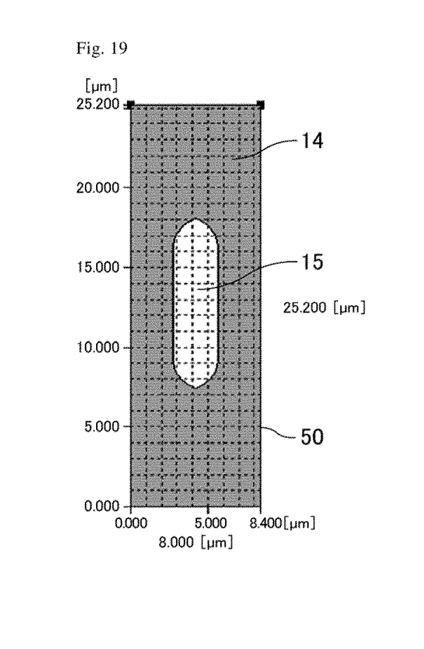

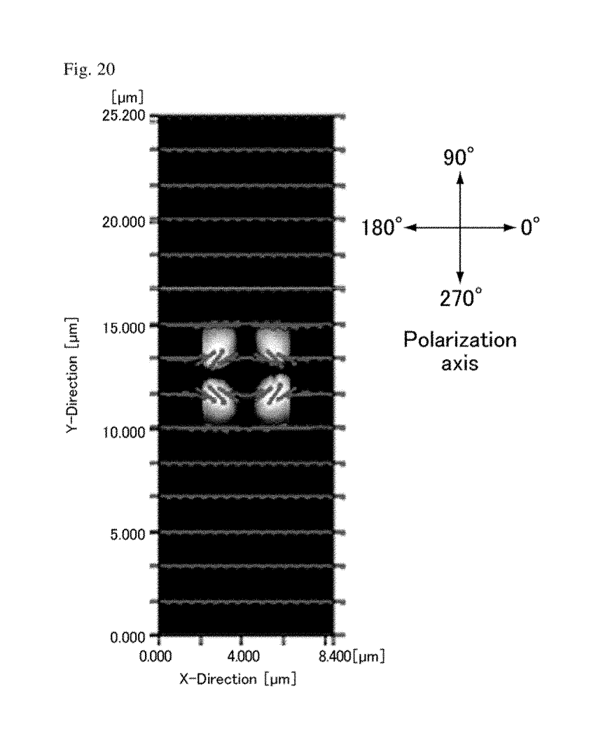

As shown in FIG. 18, the opening used in Comparative Example 2 has the same shape as the opening used in Example 2. The liquid crystal display device of Comparative Example 2 has a structure similar to that of the liquid crystal display device of Example 2, except that positive liquid crystal molecules 21 having an anisotropy of dielectric constant (Δε) of 3.2 was used instead of the negative liquid crystal molecules 21 and that the initial alignment azimuth of the positive liquid crystal molecules 21 was controlled to be parallel to the longitudinal direction of the opening. The liquid crystal display device of Comparative Example 3 has a structure similar to that of the liquid crystal display device of Example 1, except that the shape of the opening 15 in the counter electrode 14 was changed as shown in FIG. 19. The opening 15 in Comparative Example 3 is obtained by expanding the opening 15 in Example 1 used in the longitudinal direction.

### Comparison of Example 2 and Comparative Examples 2 and 3

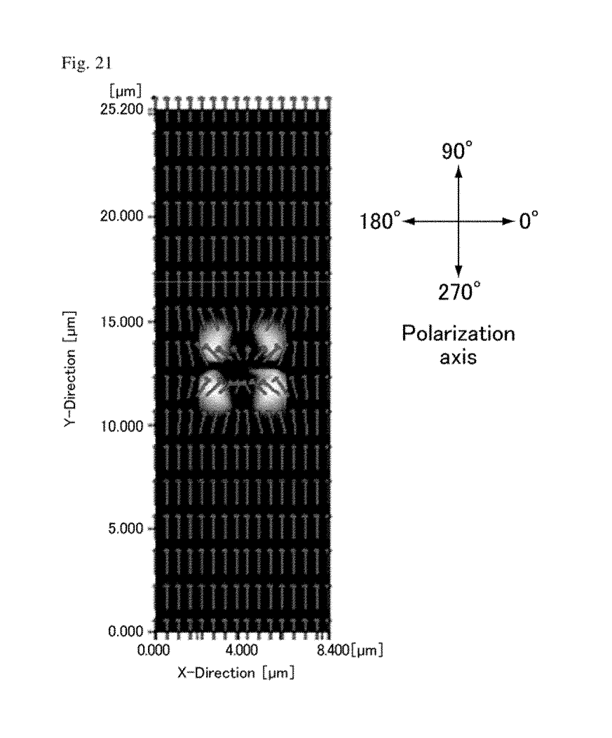

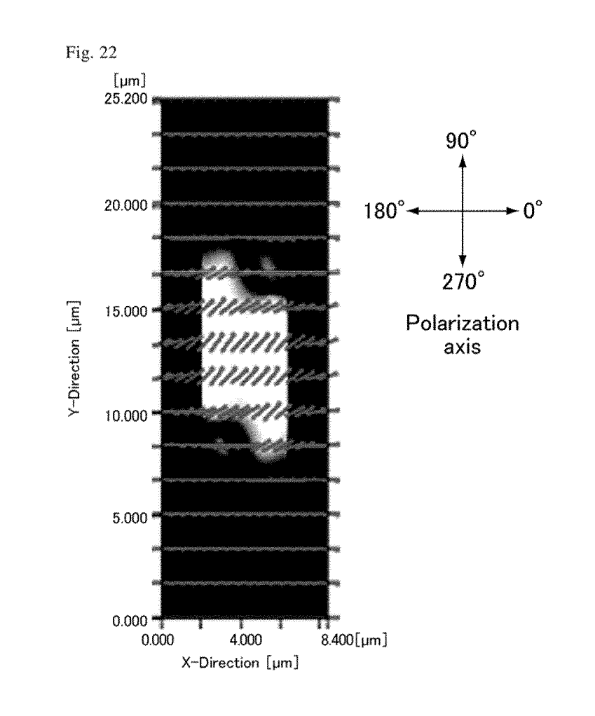

With reference to FIG. 20 to FIG. 22, Example 2 and Comparative Examples 2 and 3 are compared. FIG. 20 is a plan view showing the result of simulating the alignment distribution of liquid crystal molecules in the liquid crystal display device of Example 2 at an applied voltage of 7 V. FIG. 21 is a plan view showing the result of simulating the alignment distribution of liquid crystal molecules in the liquid crystal display device of Comparative Example 2 at an applied voltage of 6 V. FIG. 22 is a plan view showing the result of simulating the alignment distribution of liquid crystal molecules in the liquid crystal display device of Comparative Example 3 at an applied voltage of 4 V.

As shown in the simulation results of FIG. 20 and FIG. 21, the liquid crystal display device 100A of Example 2 can maintain the cross-shaped dark lines even when a high voltage of 7 V is applied, and four liquid crystal domains are formed. In contrast, the liquid crystal display device of Comparative Example 2 exhibits broken cross-shaped dark lines when a voltage of 6 V is applied. The negative liquid crystal molecules 21 thus can stabilize the alignments better than the positive liquid crystal molecules 21.

As shown in the simulation result of FIG. 22, negative liquid crystal was used in the liquid crystal display device of Comparative Example 3. In this case, the opening 15 in the counter electrode was expanded in the longitudinal direction, so that the electric field in an oblique direction generated at a circular end of the opening 15 failed to act on the center of the opening 15 and the vicinity thereof, causing a failure in fixing the cross-shaped dark lines. As a result, in Comparative Example 3, only three liquid crystal domains (a central liquid crystal domain and two small liquid crystal domains formed on the upper right side and the lower left side thereof) were formed for one opening 15.

### Example 3

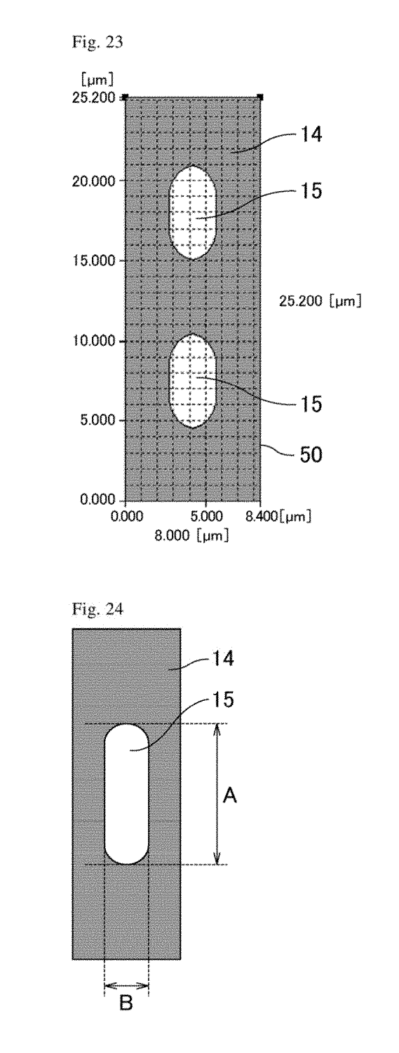

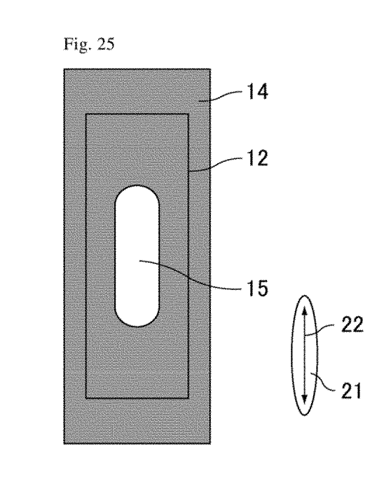

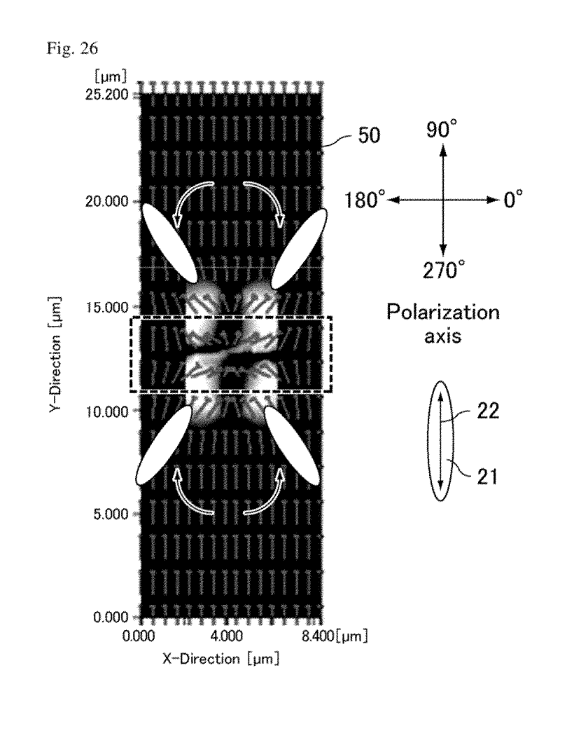

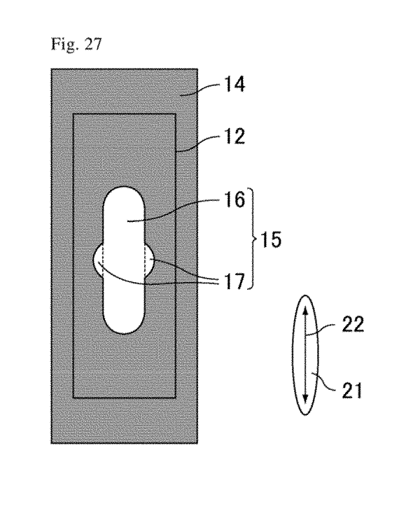

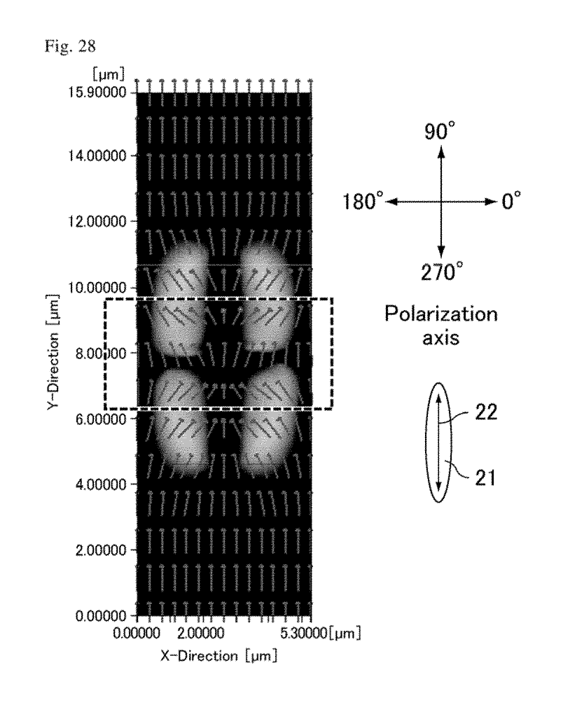

FIG. 23 is a plan view showing the shape of an opening in a counter electrode of a liquid crystal display device of Example 3. The liquid crystal display device 100A of Example 3 has a structure similar to that of the liquid crystal display device 100A of Example 1, except that the shape of the opening 15 in the counter electrode 14 is changed as shown in FIG. 23. The opening 15 used in Example 3 has a shape obtained by contracting the opening 15 used in Example 1 in the longitudinal direction, and two openings 15 are arranged in the longitudinal direction in one display unit 50.

### Comparison of Examples 1 to 3 and Comparative Examples 1 to 3

FIG. 24 is a schematic plan view for illustrating the length in the longitudinal direction and the length in the lateral direction of the opening in the counter electrode. As shown in FIG. 24, the ratio A/B was determined in Examples 1 to 3 and Comparative Examples 1 to 3, where A represents the length of the opening 15 in the longitudinal direction; and B represents the length thereof in the lateral direction. Further, the alignment state of the liquid crystal molecules 21 when voltage is applied was examined for the liquid crystal display devices of Examples 1 to 3 and Comparative Examples 1 to 3. A voltage of 4 to 7 V was applied to the liquid crystal display devices of Examples 1 to 3 and Comparative Examples 1 to 3, and the alignment stability was evaluated at each voltage. The states with fixed cross-shaped dark lines were evaluated as good, while the states with broken cross-shaped dark lines were evaluated as poor. The ratios A/B and the results of evaluating the alignment stability in Examples 1 to 3 and Comparative Examples 1 to 3 are shown in the following Table 1. Since a voltage of 6 V is used in many liquid crystal display devices, the alignments of the liquid crystal molecules 21 need to be stable when a voltage of 6 V is applied.

TABLE 1

| | Anisotropy | | | | | |
|---|---|---|---|---|---|---|
| | of dielectric | | | | | |
| | constant of liquid | | Voltage | | | |
| | crystal molecules | A/B | 4 V | 5 V | 6 V | 7 V |
| Example 1 | Negative | 2.3 | Good | Good | Good | Good |
| Example 2 | Negative | 1.5 | Good | Good | Good | Good |
| Comparative | Positive | 2.3 | Good | Good | Poor | Poor |
| Example 1 | | | | | | |
| Comparative | Positive | 1.5 | Good | Good | Poor | Poor |
| Example 2 | | | | | | |
| Comparative | Negative | 3.6 | Poor | Poor | Poor | Poor |
| Example 3 | | | | | | |
| Example 3 | Negative | 2.0 | Good | Good | Good | Good |

Table 1 shows that the negative liquid crystal molecules 21 allowed the cross-shaped dark lines to be fixed and allowed the alignments of the liquid crystal molecules 21 to be stabilized even when a high voltage of 6 V or higher was applied. In particular, with 1.5≤A/B≤2.3, the cross-shaped dark lines were not broken and the alignments of the liquid crystal molecules 21 were stabilized even when a voltage of 7 V was applied.

Consequently, with the negative liquid crystal molecules 21, the alignments of the liquid crystal molecules 21 can be stabilized even when a high voltage is applied, improving the transmittance and response speed of the liquid crystal display device. Further, the negative liquid crystal molecules 21 can eliminate the need for a protruding portion of the opening 15 in the counter electrode 14, and thus enable a narrow pitch of the opening 15 in the lateral direction, providing higher definition.

### [Additional Remarks]

One aspect of the present invention may be a liquid crystal display device including, in the given order: a first substrate; a liquid crystal layer containing liquid crystal molecules; and a second substrate, the first substrate including a first electrode, a second electrode closer to the liquid crystal layer than the first electrode is, and an insulating film between the first electrode and the second electrode, the second electrode being provided with an opening having a longitudinal shape with no protruding portion, the liquid crystal molecules being aligned parallel to the first substrate in a no-voltage-applied state where no voltage is applied between the first electrode and the second electrode, the liquid crystal molecules having negative anisotropy of dielectric constant, the opening providing four liquid crystal domains in a voltage-applied state where voltage is applied between the first electrode and the second electrode.

In this aspect, the opening has a longitudinal shape with no protruding portion and the liquid crystal molecules have negative anisotropy of dielectric constant. This can fix the cross-shaped dark lines and form four liquid crystal domains even when a high voltage is applied, improving the transmittance and the response speed. Further, the opening has a longitudinal shape with no protruding portion, and thus enables higher definition.

The opening may satisfy 1.5≤A/B≤2.3, where A represents the length of the opening in the longitudinal direction; and B represents the length thereof in the lateral direction. This embodiment can effectively fix the cross-shaped dark lines and effectively stabilize the alignments of the liquid crystal molecules even when a high voltage of 6 V or higher is applied.

The longitudinal direction of the opening may be perpendicular to the initial alignment azimuth of the liquid crystal molecules. This embodiment can improve the symmetry of the four liquid crystal domains and further stabilize the alignments of the liquid crystal molecules.

At least one end of the opening in the longitudinal direction may be rounded. This embodiment enables generation of an electric field in an oblique direction at a rounded end, further improving the response speed.

From the same viewpoint, both ends of the opening in the longitudinal direction may be rounded.

The four liquid crystal domains may be present respectively in four regions which are symmetrical about the longitudinal and lateral directions of the opening. This embodiment can further stabilize the alignments of the liquid crystal molecules.

### REFERENCE SIGNS LIST

10: First substrate
11, 31: Insulating substrate (e.g., glass substrate)
12: Pixel electrode (first electrode)
13: Insulating layer (insulating film)
14: Counter electrode (second electrode)
15: Opening
16: Longitudinal portion
17: Protruding portion
20: Liquid crystal layer
21: Liquid crystal molecules
22: Initial alignment azimuth
30: Second substrate
32: Color filter
33: Overcoat layer
41: Gate signal line (scanning conductive line)
42: Source signal line (signal conductive line)
43: TFT
50: Display unit

1. A liquid crystal display device comprising, in the given order:
a first substrate;
a liquid crystal layer containing liquid crystal molecules; and
a second substrate,
the first substrate including a first electrode, a second electrode closer to the liquid crystal layer than the first electrode is, and an insulating film between the first electrode and the second electrode,
the second electrode being provided with an opening having a longitudinal shape with no protruding portion,
the liquid crystal molecules being aligned parallel to the first substrate in a no-voltage-applied state where no voltage is applied between the first electrode and the second electrode,
the liquid crystal molecules having negative anisotropy of dielectric constant,
the opening providing four liquid crystal domains in a voltage-applied state where voltage is applied between the first electrode and the second electrode.

2. The liquid crystal display device according to claim 1,
wherein the opening satisfies 1.5≤A/B≤2.3, where A represents the length of the opening in the longitudinal direction; and B represents the length thereof in the lateral direction.

3. The liquid crystal display device according to claim 1,
wherein the longitudinal direction of the opening is perpendicular to the initial alignment azimuth of the liquid crystal molecules.

4. The liquid crystal display device according to claim 1,
wherein at least one end of the opening in the longitudinal direction is rounded.

5. The liquid crystal display device according to claim 1,
wherein the four liquid crystal domains are present respectively in four regions which are symmetrical about the longitudinal and lateral directions of the opening.
